(19) United States
(12) Patent Application Publication
(10) Pub. No.: US 2022/0039120 A1
(43) Pub. Date: Feb. 3, 2022

(54) EXTENSION OF SOFT AP CAPABILITIES BASED ON TRIGGER FRAME

(71) Applicant: Facebook Technologies, LLC, Menlo Park, CA (US)

(72) Inventor: Chunyu Hu, San Jose, CA (US)

(21) Appl. No.: 16/942,367

(22) Filed: Jul. 29, 2020

(51) Int. Cl. H04W 72/12

(52) U.S. Cl. CPC H04W 72/1268

(57) ABSTRACT

Disclosed herein are related to a system and a method of communication. In one aspect, a first device receives a trigger frame via a unicast transmission from a second device configured to schedule the first device for an uplink transmission by the first device. The trigger frame may include a common field and a user field. The common field may include a first set of fields, and the user field may include a second set of fields. In one aspect, the first device generates a response frame, in response to a first subset of the first set of fields and a second subset of the second set of fields, and transmits the response frame to the second device. The first device may generate the response frame, irrespective of a third subset of the first set of fields and a fourth subset of the second set of fields.

### FIELD OF DISCLOSURE

The present disclosure is generally related to communications, including but not limited to extending capabilities of a soft enabled access point (AP) based on a trigger frame based frame exchange sequence.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of an artificial reality (e.g., a VR space, an AR space, or a MR space). In one implementation, an image of a virtual object is generated by a console communicatively coupled or tethered to the HWD. In some setups, the console may have access to a wireless network and the HWD accesses the network via the console device.

### SUMMARY

Various embodiments disclosed herein are related to a method of wireless communication between devices. In some embodiments, the method includes receiving, by a first device, a trigger frame via a unicast transmission from a second device configured to schedule the first device for an uplink transmission by the first device. The trigger frame may include a common field and a user field. The common field may include a first set of fields, and the user field may include a second set of fields. In some embodiments, the method includes generating, by the first device, a response frame, in response to a first subset of the first set of fields and a second subset of the second set of fields.

In some embodiments, generating, by the first device, the response frame includes generating, by the first device, the response frame, irrespective of a third subset of the first set of fields and a fourth subset of the second set of fields. In some embodiments, the first subset of the first set of fields includes a type field indicating a type of action to trigger, and a length field indicating length information of the response frame. In some embodiments, the type of action includes one of an uplink traffic scheduling, a buffer status report poll, or a bandwidth query report poll. In some embodiments, the second subset of the second set of fields includes an identification field identifying the first device.

In some embodiments, the second device comprises a soft enabled access point, a mobile access point, or peer to peer group owner (P2P-GO). In some embodiments, the first device comprises a head wearable display (HWD), a controller, a smart watch, or a mobile device. In some embodiments, the response frame is transmitted via a single user physical layer convergence protocol (PLCP) protocol data unit (SU PPDU).

Various embodiments disclosed herein are related to a first device for communication. In some embodiments, the first device includes one or more processors configured to receive a trigger frame via a unicast transmission from a second device configured to schedule the first device for an uplink transmission by the first device. The trigger frame may include a common field, a user field, and other possible fields. The common field may include a first set of fields, and the user field may include a second set of fields. In some embodiments, the one or more processors are configured to generate a response frame, in response to a first subset of the first set of fields and a second subset of the second set of fields. In some embodiments, the one or more processors are configured to transmit the response frame to the second device.

In some embodiments, the one or more processors are configured to generate the response frame, irrespective of a third subset of the first set of fields and a fourth subset of the second set of fields. In some embodiments, the first subset of the first set of fields includes a type field indicating a type of action to trigger, and a length field indicating length information of the response frame. In some embodiments, the type of action includes one of an uplink traffic scheduling, a buffer status report poll, or a bandwidth query report poll. In some embodiments, the second subset of the second set of fields includes an identification field identifying the first device.

In some embodiments, the second device is a soft enabled access point, a mobile access point, or P2P-GO. In some embodiments, the first device comprises a head wearable display (HWD), a controller, a smart watch, or a mobile device. In some embodiments, the response frame is transmitted via a SU PPDU.

Various embodiments disclosed herein are related to a non-transitory computer readable medium comprising instructions for communication. In some embodiments, the instructions when executed by one or more processors of a first device cause the one or more processors to receive a trigger frame via a unicast transmission from a second device that is configured to schedule the first device for an uplink transmission by the first device. The trigger frame may include a common field and a user field. The common field may include a first set of fields, and the user field may include a second set of fields. In some embodiments, the instructions when executed by the one or more processors of a first device cause the one or more processors to generate a response frame, in response to a first subset of the first set of fields and a second subset of the second set of fields. In some embodiments, the instructions when executed by the one or more processors of a first device cause the one or more processors to transmit the response frame to the second device.

In some embodiments, the instructions when executed by the one or more processors cause the one or more processors to generate the response frame, irrespective of a third subset of the first set of fields and a fourth subset of the second set of fields. In some embodiments, the first subset of the first set of fields includes a type field indicating a type of action to trigger, and a length field indicating length information of the response frame. In some embodiments, the type of action includes one of an uplink traffic scheduling, a buffer status report poll, or a bandwidth query report poll.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is an example uplink frame exchange sequence, according to an example implementation of the present disclosure.

FIG. 4 is an example downlink frame exchange sequence, according to an example implementation of the present disclosure.

FIG. 5 is an example trigger frame, according to an example implementation of the present disclosure.

FIG. 6 is an interaction diagram of a process of conducting uplink transmission between two devices, according to an example implementation of the present disclosure.

FIG. 7 is a block diagram of a computing environment according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems and methods for extending capabilities of soft enabled access point (“soft AP”) based on a trigger frame based frame exchange sequence. A soft AP may be a non-router communication device, for example with a Wi-Fi communication interface, to be configured as a wireless access point to host or create a wireless hotspot. In one aspect, a first device is or operates as a head wearable display (HWD), a controller, a smart watch, a mobile device, a station device, or a client device. In one aspect, a second device is or operates as a soft enabled access point, a mobile access point, or peer to peer group owner (P2P-GO). The second device may be configured to allow the first device to connect to a network via the second device. The second device may transmit a trigger frame to the first device via a unicast transmission. The trigger frame may include a common field and a user field. The common field may include a first set of fields and the user field may include a second set of fields. The trigger frame may comply with, for example, IEEE 802.11ax protocol. The first device may receive the trigger frame and generate a response frame, in response to the trigger frame. In one approach, the first device extracts one or more subfields of the common field and the user field, and generate the response frame irrespective of other subfields of the common field and the user field. The first device may transmit the response frame to the second device. Based on the trigger frame, the second device may perform an uplink traffic scheduling, buffer status report poll, bandwidth query report poll, etc.

Beneficially, the disclosed communication based on a trigger frame and a response frame provides several advantages. In one aspect, existing soft AP devices are implemented based a mobile wireless chipset solution and are not capable of a full functionality of an AP device, including receiving the HE TB PPDU (a form of uplink multi-user PPDU) and uplink transmission rate/power control design. Hence, the communication between the existing soft AP devices and associated client device(s) may not conduct the triggered-based frame exchange sequence. The disclosed communication allows the soft AP device to generate and transmit a trigger frame to initiate the uplink data transmission. In response to the trigger frame, the client device may transmit a response frame, based on which the uplink transmission can be performed. As a result, the soft AP device can perform uplink traffic scheduling in coordination to its downlink transmission, thereby improving the network utilization and reducing medium access contention. In another aspect, the second device operating as a soft AP may extend its capabilities to support more functionalities of a full AP (e.g., buffer status report polling, bandwidth query report polling, etc.). In yet another aspect, when used in the downlink (DL) transmission, the soft AP device can use the trigger frame to specify the transmission rate for the responding frames (e.g., ACK, BlockACK or Multi-TID/STA BlockACK) from the client device.

In one implementation, an image of a virtual object is generated by a console (e.g., soft AP) communicatively coupled to a HMD (e.g., client device). In one example, the HIVID includes various sensors that detect a location of the HIVID and a gaze direction of the user wearing the HIVID, and transmits the detected location and gaze direction to the console through a wired connection or a wireless connection. The console can determine a user's view of the space of the artificial reality according to the detected location and gaze direction, and generate an image of the space of the artificial reality corresponding to the user's view. The console can transmit the generated image to the HMD, by which the image of the space of the artificial reality corresponding to the user's view can be presented to the user. In one aspect, the process of detecting the location of the HIVID and the gaze direction of the user wearing the HIVID, and presenting the image to the user should be performed within a frame time (e.g., less than 11 ms). Any latency between a movement of the user wearing the HIVID and an image displayed corresponding to the user movement can cause judder, which may result in motion sickness and can degrade the user experience. In one aspect, the console (or soft AP) can adaptively or dynamically schedule a client device for uplink transmission to improve communication link and reduce latency.

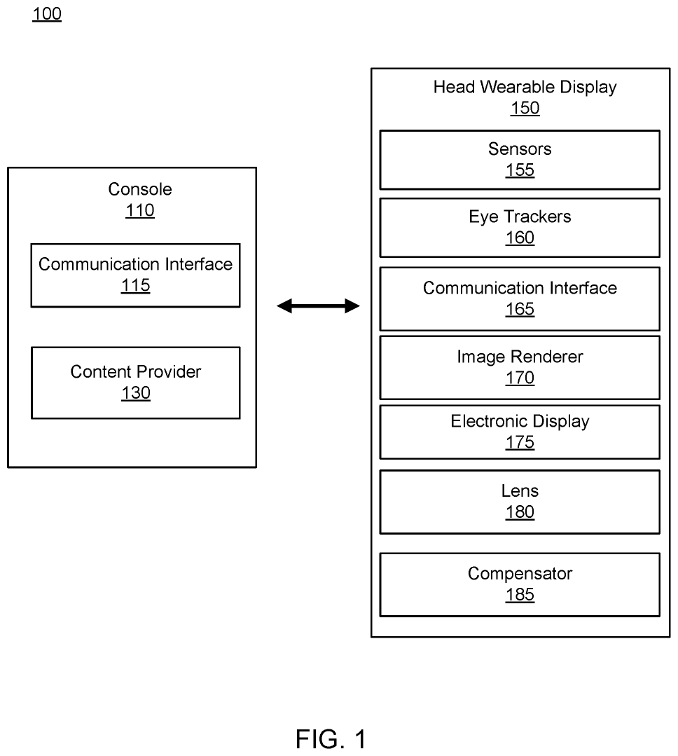

FIG. 1 is a block diagram of an example artificial reality system environment 100 in which a console 110 operates. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HIVID), head mounted device (HMD), head wearable device (HWD), head worn display (HWD) or head worn device (HWD). In one aspect, the HWD 150 may detect its location and a gaze direction of the user wearing the HWD 150, and provide the detected location and the gaze direction to the console 110. The console 110 may determine a view within the space of the artificial reality corresponding to the detected location and the gaze direction, and generate an image depicting the determined view. The console 110 may provide the image to the HWD 150 for rendering. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In the embodiments, in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150 and the determined gaze direction of the user. Moreover, through the communication link, the communication interface 165 may receive from the console 110 sensor measurements indicating or corresponding to an image to be rendered.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced. In one aspect, the process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms). In one aspect, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable). Through the communication link, the communication interface 115 may receive from the HWD 150 sensor measurements indicating the determined location and orientation of the HWD 150 and/or the determined gaze direction of the user. Moreover, through the communication link, the communication interface 115 may transmit to the HWD 150 data describing an image to be rendered.

The content provider 130 is a component that generates content to be rendered according to the location and orientation of the HWD 150 and/or the gaze direction of the user of the HWD 150. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space. The content provider 130 may generate image data describing an image of the determined view of the artificial reality space, and transmit the image data to the HWD 150 through the communication interface 115. In some embodiments, the content provider 130 generates metadata including motion vector information, depth information, edge information, object information, etc., associated with the image, and transmits the metadata with the image data to the HWD 150 through the communication interface 115. The content provider 130 may encode the data describing the image, and can transmit the encoded data to the HWD 150. In some embodiments, the content provider 130 generates and provides the image to the HWD 150 periodically (e.g., every one second).

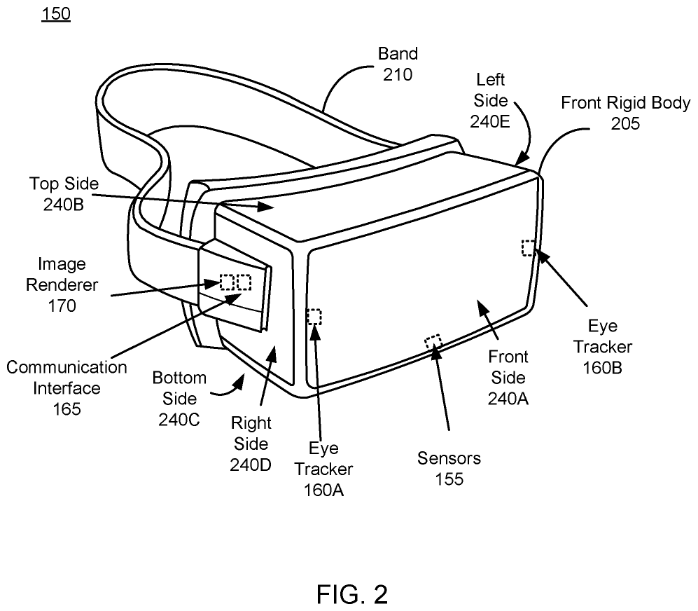

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

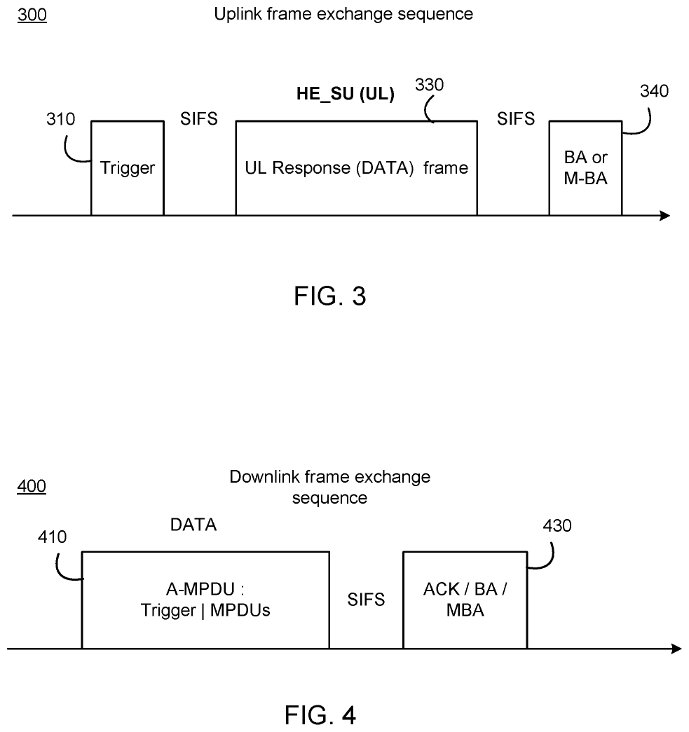

FIG. 3 is an example frame sequence 300 of uplink communication between two devices, according to an example implementation of the present disclosure. In one example, a soft AP (e.g., console 110) transmits a trigger frame 310 to a client device (e.g., HWD 150, controller, smart phone, smart watch, etc.). The soft AP may select a single client device from multiple client devices nearby, and transmit the trigger frame 310 to the selected client device through a unicast transmission. The trigger frame 310 may indicate a type of request or polling. Example types include basic, beamforming report poll, MU-BAR, MU-RTS, Buffer status report poll. The client device may receive the trigger frame 310 and generate a response frame 330, in response to the trigger frame 310. The client device may transmit the response frame 330 after short interface space (SIFS) (e.g., 10/16 μsec) from end of the trigger frame 310. The response frame may respond to the request or polling indicated in the trigger frame 310. For basic type, the response frame may include data frames. For beamforming report poll, the response frame may include beam forming sounding report frame. For MU-BAR, the response frame may include block-ACK frame. For MU-RTS, the response frame may include a clear-to-send (CTS). For buffer status report poll, the response frame may include QoS-Null frame containing the buffer status info. The response frames may be provided in Aggregate MAC Protocol Data Unit (A-MPDU) encapsulated in a SU PPDU. In response to the response frame 330, the soft AP (e.g., console 110) may initiate one or more processes. Examples of the processes include processing the received uplink frame(s). In one example, the soft AP (e.g., the console 110) generates an additional acknowledgement frame 340. In some embodiments, the soft AP (e.g., console 110) may initiate one or more processes according to the response frames 330 without generating and transmitting the additional frame 340.

FIG. 4 is an example timing diagram 400 of downlink communication between two devices, according to an example implementation of the present disclosure. In one example, soft AP (e.g., console 110) transmits a trigger frame 410 encapsulated in an A- MPDU together with additional data frames to a client devices (e.g., HWD 150, controllers, smart phone, smart watches, etc.). The client device may receive the trigger frame 410 and generate a corresponding response frame 430 in response to the trigger frame 410. The response frame 430 may be acknowledgement frame (ACK) block acknowledgement frame (BA). The client device may transmit the response frame 430 after SIFS (e.g., 10/16 μsec) from end of the trigger frame 410.

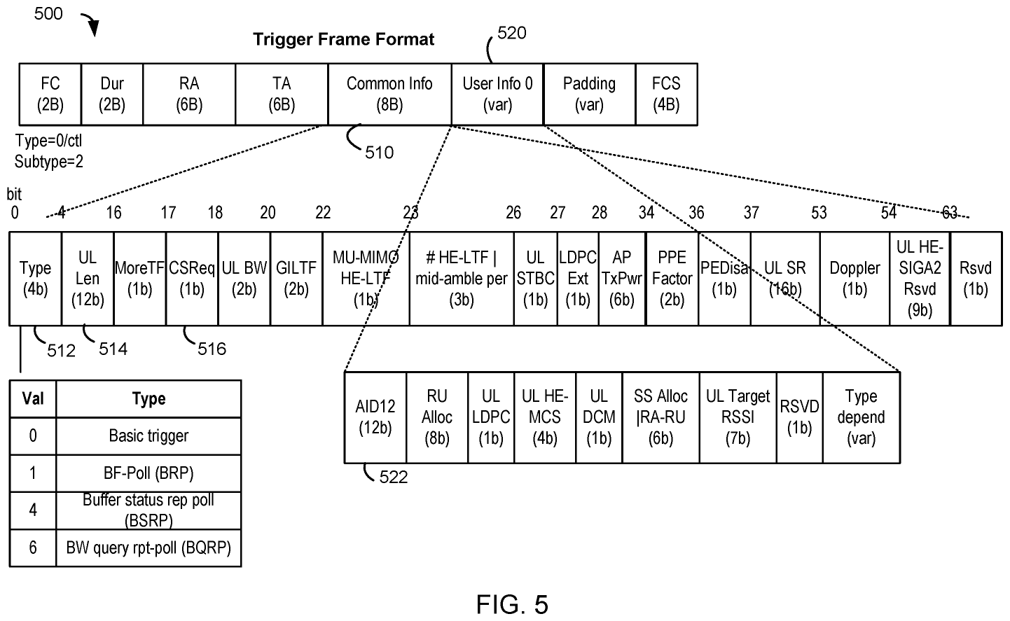

FIG. 5 is an example trigger frame 500, according to an example implementation of the present disclosure. The trigger frame 500 may be the trigger frame 310 shown in FIG. 3 or the trigger frame 410 shown in FIG. 4. In some embodiments, the trigger frame 500 is generated and transmitted by the communication interface 115. The communication interface 115 may transmit the trigger frame 500 to a client device (e.g., HWD 150, smart watch, a controller, or a mobile device, etc.). In one aspect, the trigger frame 500 complies with IEEE 802.11ax protocol. The trigger frame 500 may be a basic trigger frame, buffer status report poll (BSRP) trigger frame, or beamforming report poll (BRP) trigger frame. In response to the trigger frame 500, the communication interface 165 of the HWD 150 may generate and transmit a response frame using HE SU PPDU. In some embodiments, the trigger frame 500 includes more, or fewer, or different fields than shown in FIG. 5.

In some embodiments, the trigger frame 500 includes a common field 510 (also referred to as “a common information field 510”) and a user field 520 (also referred to as “a user information field 520”). The common field 510 may include a first set of fields, and the user field 520 may include a second set of fields. The common field 510 may be directed to or accessed/accessible by one or more client devices, where the user field 520 may be directed to or accessed by a particular client device associated with the user field 520.

In one example, the common field 510 includes at least a type field 512, a length field 514, and a carrier sense (CS) required field 516. The type field 512 may indicate a type of the trigger frame 500. Example types of the trigger frame 500 include a basic trigger, a beamforming report poll (BRP), a buffer status report poll (BSRP), and a bandwidth query report poll (BQRP). The length field 514 may indicate length information of a response frame. The CS required field 516 may indicate whether a carrier sense should be performed by the client device (e.g., HWD 150) or not. In some embodiments, the common field 510 includes additional fields conforming to IEEE 802.11ax protocol.

In one aspect, a client device (e.g., HWD 150) may generate a response frame according to the type field 512, the length field 514 and the CS required field 516. For example, in response to the common field 510, the client device (e.g., HWD 150) may generate a response frame according to the type of the trigger frame 500 specified by the type field 512. For example, in response to the length field 514, the client device (e.g., HWD 150) may generate a response frame having the length specified by the length field 514. For example, in response to the CS required field 516, the client device (e.g., HWD 150) may perform or bypass the carrier sense process. In one aspect, the client device (e.g., HWD 150) may generate the response frame irrespective of (e.g. by ignoring, bypassing, skipping or not processing) other fields of the common field 510. Accordingly, the client device can conserve power by omitting decoding or processing of the other fields of the common field 510.

In one example, the user field 520 includes AID field 522. The AID field 522 may indicate an identification of an intended client device (e.g., HWD 150). According to the AID field 522, the trigger frame 500 may be received and decoded by the intended client device. Hence, the trigger frame 500 may be unicast to the intended client device. In some embodiments, the user field 520 includes additional fields conforming to IEEE 802.11ax protocol. In one aspect, the client device (e.g., HWD 150) may generate the response frame irrespective of other fields of the user field 520. Accordingly, the client device can conserve power by omitting decoding or processing of the other fields of the user field 520.

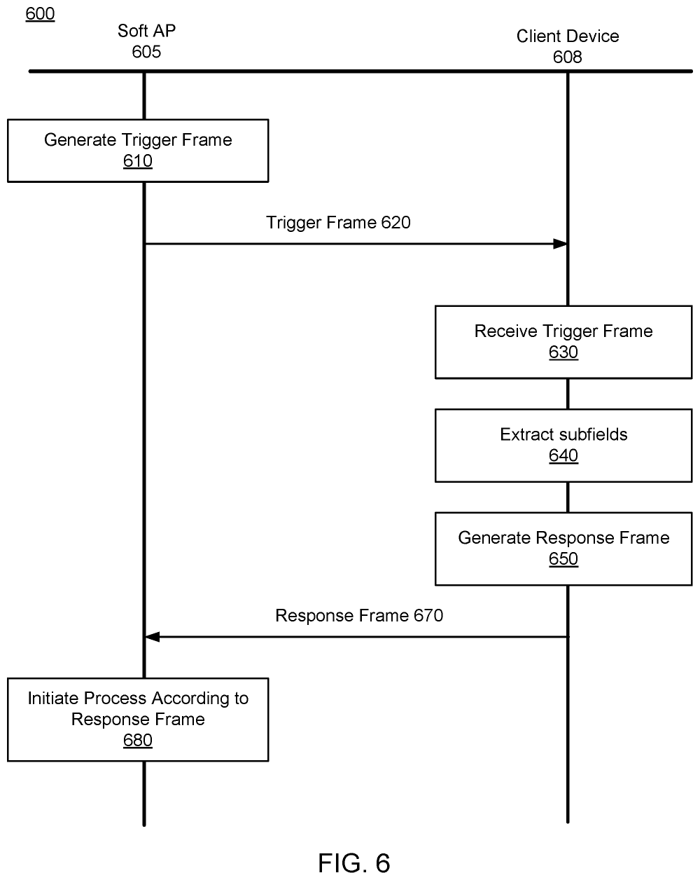

FIG. 6 is an interaction diagram showing a process 600 of conducting uplink transmission between two devices, according to an example implementation of the present disclosure. In some embodiments, the process 600 is performed by a soft AP 605 and a client device 608. The soft AP 605 may be the console 110, or any non-router communication device with a Wi-Fi communication interface. The client 608 may include a HWD 150, a smart watch, controller(s), etc. In some embodiments, the process 600 is performed by other entities. In some embodiments, the process 600 includes more, fewer, or different steps than shown in FIG. 6.

In one approach, the soft AP 605 generates 610 a trigger frame. The trigger frame may be the trigger frame 500 shown in FIG. 5. The trigger frame may comply with IEEE 802.11ax protocol. In some embodiments, the trigger frame includes a common field 510 and a user field 520. The common field 510 may include a first set of fields and the user field 520 may include a second set of fields. The common field 510 may be directed to or accessed by multiple client devices, where the user field 520 may be directed to or accessed by a particular client device associated with the user field 520. In one example, the common field 510 includes at least a type field 512, a length field 514, and a carrier sense (CS) required field 516. The soft AP 605 may utilize one of the basic trigger, BFRP, BSRP, BQRP to extend its capabilities. The length field 514 may indicate a length of a response frame. The CS required field 516 may indicate whether a carrier sense should be performed by the client device (e.g., HWD 150) or not. The common field 510 may include additional fields conforming to IEEE 802.11ax protocol. In one example, the user field 520 includes an AID field 522. The AID field 522 may indicate an identification of an intended (receiving or destination) client device (e.g., HWD 150). According to the AID field 522, the trigger frame 500 may be received and decoded by the intended client device.

In one approach, the soft AP 605 transmits 620 the trigger frame. The soft AP 605 may unicast the trigger frame to a specific client device 608. In one example, the RA (Receiver Address) field is the MAC address of the client device 608. In one example, the AID field of the user information indicates or specifies an intended client device 608 to respond to the trigger frame.

In one approach, the client device 608 receives 630 the trigger frame from the soft AP 605. The client device 608 may extract 640 subfields from a plurality of fields of the trigger frame, and generate 650 a response frame according to the extracted subfields. For example, the client device 608 generates a response frame according to one or more subfields of the common field, and one or more subfields of the user field. For example, the client device 608 may generate the response frame, according to the AID field 522, the type field 512, the length field 514 and the CS required field 516. For example, the client device (e.g., HWD 150) may compare its stored identification number with the identification number included the AID field 522, and proceed to generate the response frame, in response to the stored identification number matching the identification number included in the AID field 522. The client device may bypass generating a response frame, in response to its stored identification number not matching the identification number included in the AID field 522. In one example, in response to determining that its stored identification number matches the identification number included in the AID field 522, the client device (e.g., HWD 150) may generate a response frame according to the type of the trigger frame 500 specified by the type field 512. The client device (e.g., HWD 150) may generate the response frame having the length specified by the length field 514. In one example, in response to the CS required field 516, the client device (e.g., HWD 150) may perform or bypass the carrier sense process. The carrier sense process may be performed to comply with a channel access rule specified in 802.11 protocol. In one aspect, the client device (e.g., HWD 150) may generate the response frame irrespective of remaining fields of the common field 510 and the user field 520, and may bypass, decoding or interpreting the other fields. Accordingly, the client device can conserve power by omitting decoding or processing of the other fields of the common field 510.

In one approach, the client device 608 transmits 670 the response frame. The client device 608 may transmit the response frame in HE SU PPDU. The benefit is that since there is only one responding STA, HE SU PPDU format can be used and can simplify both the generation and the decoding procedure at the transmitter and receiver sides. In addition, the soft AP device is no longer required to conduct the UL rate adaptation and associated transmission power control for the client device.

In one approach, the soft AP 605 receives the response frame from the client device 608, and initiates 680 one or more processes according to the response frame. Examples of processes include an uplink transmission corresponding to the type of trigger frame transmitted by the soft AP 605. Accordingly, the soft AP 605 may extend its capabilities to support more functionalities of a full AP (e.g., uplink traffic scheduling, buffer status report poll, bandwidth query report poll, etc.).

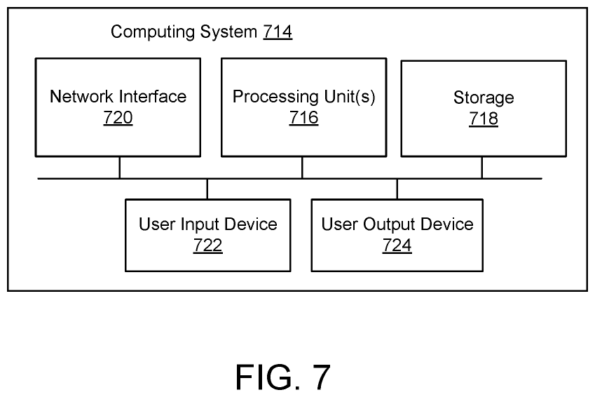

Various operations described herein can be implemented on computer systems. FIG. 7 shows a block diagram of a representative computing system 714 usable to implement the present disclosure. In some embodiments, the console 110, the HWD 150 or both of FIG. 1 are implemented by the computing system 714. Computing system 714 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 714 can be implemented to provide VR, AR, MR experience. In some embodiments, the computing system 714 can include conventional computer components such as processors 716, storage device 718, network interface 720, user input device 722, and user output device 724.

Network interface 720 can provide a connection to a wide area network (e.g., the Internet) to which WAN interface of a remote server system is also connected. Network interface 720 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 722 can include any device (or devices) via which a user can provide signals to computing system 714; computing system 714 can interpret the signals as indicative of particular user requests or information. User input device 722 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 724 can include any device via which computing system 714 can provide information to a user. For example, user output device 724 can include a display to display images generated by or delivered to computing system 714. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 724 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 716 can provide various functionality for computing system 714, including any of the functionality described herein as being performed by a server or client, or other functionality associated with message management services.

It will be appreciated that computing system 714 is illustrative and that variations and modifications are possible. Computer systems used in connection with the present disclosure can have other capabilities not specifically described here. Further, while computing system 714 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “tethered” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
receiving, by a first device, a trigger frame via a unicast transmission from a second device configured to schedule the first device for an uplink transmission by the first device, the trigger frame including a common field and a user field, the common field including a first set of fields, the user field including a second set of fields;
generating, by the first device, a response frame, in response to a first subset of the first set of fields and a second subset of the second set of fields; and
transmitting, by the first device to the second device, the response frame.

2. The method of claim 1, wherein generating, by the first device, the response frame includes:
generating, by the first device, the response frame, irrespective of a third subset of the first set of fields and a fourth subset of the second set of fields.

3. The method of claim 1, wherein the first subset of the first set of fields includes a type field indicating a type of action to trigger, and a length field indicating a length of the response frame.

4. The method of claim 3, wherein the type of action includes one of an uplink traffic scheduling, a buffer status report poll, or a bandwidth query report poll.

5. The method of claim 1, wherein the second subset of the second set of fields includes an identification field identifying the first device.

6. The method of claim 1, wherein the second device is a soft enabled access point, a mobile access point, or peer to peer group owner (P2P-GO).

7. The method of claim 1, wherein the first device comprises a head wearable display (HWD), a controller, a smart watch, or a mobile device.

8. The method of claim 1, wherein the response frame is transmitted via a single user physical layer convergence protocol (PLCP) protocol data unit (SU PPDU).

9. A first device comprising:
one or more processors configured to:
receive a trigger frame via a unicast transmission from a second device configured to schedule the first device for an uplink transmission by the first device, the trigger frame including a common field and a user field, the common field including a first set of fields, the user field including a second set of fields,
generate a response frame, in response to a first subset of the first set of fields and a second subset of the second set of fields, and
transmit the response frame to the second device.

10. The first device of claim 9, wherein the one or more processors are configured to generate the response frame, irrespective of a third subset of the first set of fields and a fourth subset of the second set of fields.

11. The first device of claim 9, wherein the first subset of the first set of fields includes a type field indicating a type of action to trigger, and a length field indicating a length of the response frame.

12. The first device of claim 11, wherein the type of action includes one of an uplink traffic scheduling, a buffer status report poll, or a bandwidth query report poll.

13. The first device of claim 9, wherein the second subset of the second set of fields includes an identification field identifying the first device.

14. The first device of claim 9, wherein the second device is a soft enabled access point, a mobile access point, or peer to peer group owner (P2P-GO).

15. The first device of claim 9, wherein the first device comprises a head wearable display (HWD), a controller, a smart watch, or a mobile device.

16. The first device of claim 9, wherein the response frame is transmitted via a single user physical layer conformance procedure (PLCP) protocol data unit (SU PPDU).

17. A non-transitory computer readable medium comprising instructions when executed by one or more processors of a first device cause the one or more processors to:
receive a trigger frame via a unicast transmission from a second device configured to schedule the first device for an uplink transmission by the first device, the trigger frame including a common field and a user field, the common field including a first set of fields, the user field including a second set of fields,
generate a response frame, in response to a first subset of the first set of fields and a second subset of the second set of fields, and
transmit the response frame to the second device.

18. The non-transitory computer readable medium of claim 17, wherein the instructions when executed by the one or more processors cause the one or more processors to generate the response frame, irrespective of a third subset of the first set of fields and a fourth subset of the second set of fields.

19. The non-transitory computer readable medium of claim 17, wherein the first subset of the first set of fields includes a type field indicating a type of action to trigger, and a length field indicating a length of the response frame.

20. The non-transitory computer readable medium of claim 19, wherein the type of action includes one of an uplink traffic scheduling, a buffer status report poll, or a bandwidth query report poll.
